(19) United States
(12) Patent Application Publication
(10) Pub. No.: US 2003/0076547 A1
(43) Pub. Date: Apr. 24, 2003

(54) System and method for fast scanning

(76) Inventor: Nigel M-F Cheung, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/012,775

(22) Filed: Oct. 22, 2001

(51) Int. Cl. H04N 1/04

(52) U.S. Cl. 358/474

(57) ABSTRACT

A method for scanning an object, for example a document, by an image scanner is disclosed. The method comprises performing an initial scan of the object by displacing a carriage carrying a light source and at least one photosensitive device from a home position to an end position and performing a final scan by then displacing the carriage from the end position to the home position.

### TECHNICAL FIELD OF THE INVENTION

The present invention relates generally to the field of image capture devices, and more particularly to a system and method for fast scanning.

### BACKGROUND OF THE INVENTION

The use of scanners has substantially increased over the years. Scanners are increasingly being used to scan different kinds of objects, such as documents, photographs, negatives, transparencies and/or the like. However, the speed of scanning has not kept pace with the increase in the use of scanners. Typically it takes a substantial amount of time to scan an object. The scan times vary depending on the type of object being scanned, the size of the object being scanned, and the resolution at which an object is being scanned. For example, in order to scan a colored photograph of size 8.5″×11″ at a resolution of 600 dots per inch, existing scanners may take several minutes.

### SUMMARY OF THE INVENTION

In accordance with an embodiment of the present invention, a method for scanning an object by an image scanner is disclosed. The method comprises performing an initial scan of the object by displacing a carriage carrying a light source and at least one photosensitive device from a home position to an end position and performing a final scan by then displacing the carriage from the end position to the home position.

In accordance with another embodiment of the present invention, an image scanner is disclosed. The image scanner comprises a platen, a carriage disposed below the platen and having a displacement axis substantially parallel to the platen, a light source and at least one photosensitive device disposed on the carriage, and the carriage having a displacement from a home position to an end position along the displacement axis in an initial scan operation to provide an initial image of an object on the platen and a subsequent displacement from the end position to the home position in a final scan operation to provide a final scanned image of the object, wherein the carriage does not return to the home position between the initial scan operation and the final scan operation.

### BRIEF DESCRIPTION OF THE DRAWINGS

For a more complete understanding of the present invention, the objects and advantages thereof, reference is now made to the following descriptions taken in connection with the accompanying drawings in which:

FIGS. 1A and 1B are perspective views of an image capture device;

FIGS. 2A and 2B are top plan views of a platen of a scanner to illustrate a conventional scanning operation;

FIG. 3 is a flowchart of a method of scanning according to an embodiment of the present invention; and

FIG. 4 is a top plan view of a platen of a scanner to illustrate a scanning operation according to an embodiment of the present invention.

### DETAILED DESCRIPTION OF THE DRAWINGS

The preferred embodiment of the present invention and its advantages are best understood by referring to FIGS. 1 through 4 of the drawings.

FIG. 1A is a perspective view of an image capture device, such as a document scanner 10. FIG. 1B is a perspective view of document scanner 10 with the top cover 12 removed. Document scanner 10 includes a transparent platen 14 on which an object to be scanned, such as a document or other item, may be placed. The scanner may be coupled to a computer system (not shown) to facilitate control of the scanner. If desired, the image capture device could be part of a copier, a facsimile machine, or a machine that may make a digital image for storage, transmission or further processing.

Preferably, a carriage 16 disposed in scanner 10 supports one or more scanning devices or subsystems, such as a light source 18, an internal optical system (not shown) and a photosensitive device (not shown). Carriage 16 is capable of moving along one or more support rails 22A and 22B. As carriage 16 moves along the support rails, light source 18 radiates light that passes through platen 14 and is reflected off the document placed thereon. The reflected light is collected by the internal optical system and directed onto the photosensitive device. The photosensitive device converts light reflected from light source 18 into one or more electrical signals.

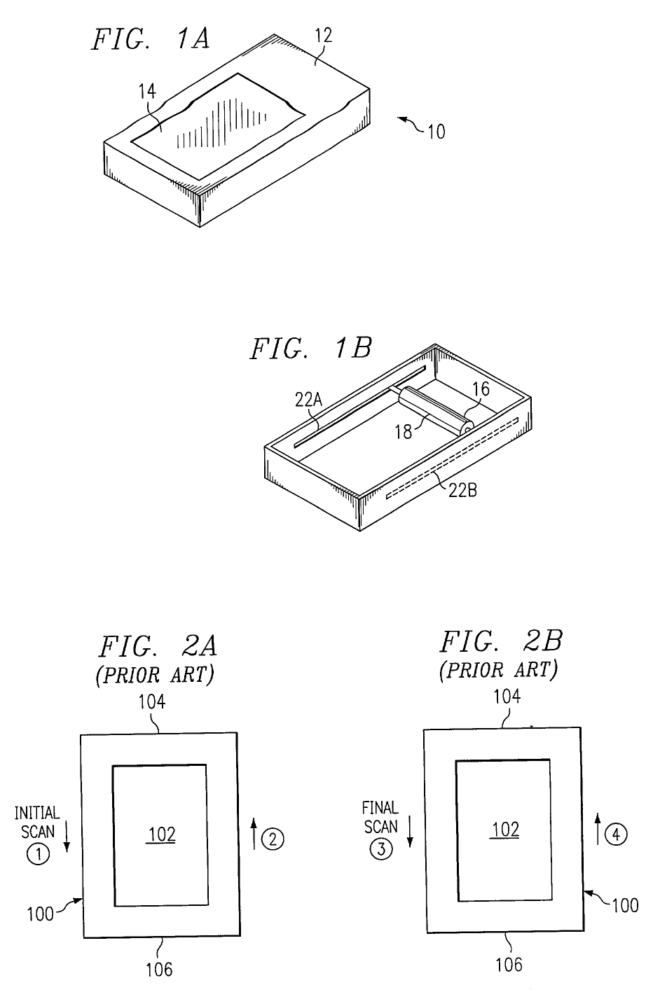

FIGS. 2A and 2B are top plan views of a platen of a scanner to illustrate a conventional scanning operation. As shown in FIGS. 2A and 2B, an object 102 to be scanned is placed on platen 100 of the scanner. A typical scanning operation involves two separate scans, an initial scan and a final scan. After the user initiates a scanning operation, an initial scan is performed by the scanner. In general, the initial scan is simply a preview scan performed at a low resolution. The low resolution scanning allows the initial scan to be quickly performed. During the initial scan, carriage 16 moves from a home position 104 towards an end position 106 scanning object 102 at a low resolution. After the initial scan is completed, the carriage returns from end position 106 to home position 104.

After the carriage returns to its original home position, the user can select the values for various parameters such as resolution of the scan, color, scan area, exposure and/or the like to be used during the final scan. The final scan is then initiated based at least in part on the parameters set by the user. During the final scan operation, the carriage once again moves from home position 104 towards end position 106 to scan the object based on the selected parameters, for example at the selected resolution. The final scan generally takes longer than the initial scan as it is typically performed at a higher resolution than the initial scan. After the carriage reaches end position 106 thereby completing the final scan, it again moves back to home position 104.

It may be seen from the foregoing that the conventional scanning operation typically involves two separate scan cycles, where each cycle involves a complete round trip displacement of the carriage between home position 104 and end position 106. Thus, the prior art method for scanning an object is time consuming as it requires two full round-trip sweeps of the carriage to complete the scan operation. Assuming that the movement of the carriage from home position 104 to end position 106 to perform the initial scan takes Xᵢ units of time; the movement of the carriage from end position 106 to home position 104 takes Xᵣ units of time; and the movement of the carriage from home position 104 to end position 106 to perform the final scan takes X_{f} units of time, the prior art scanning operation takes (Xᵢ+2*Xᵣ+X_{f}) units of time.

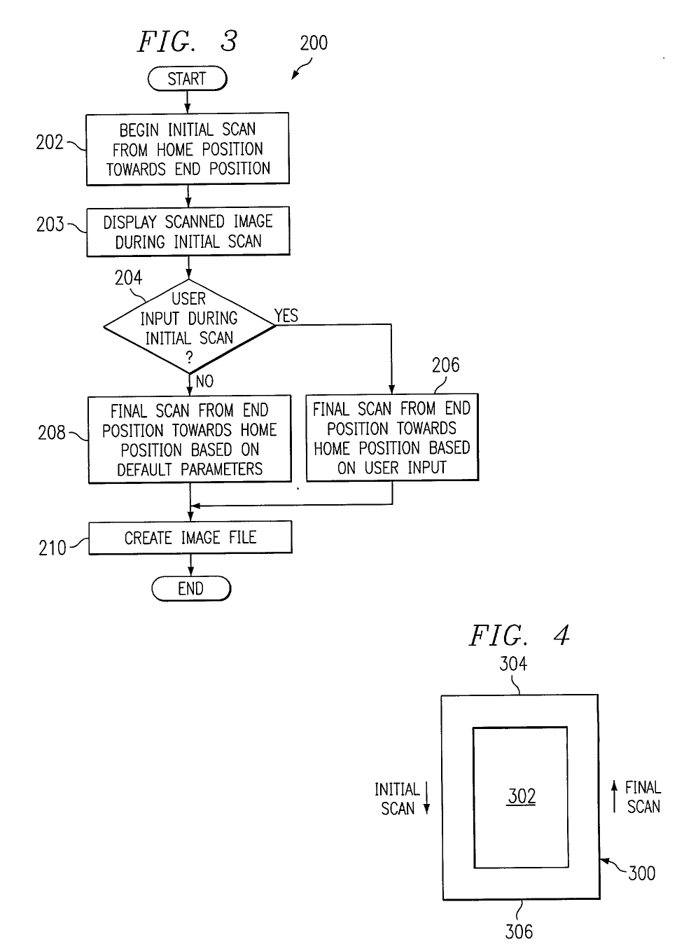

FIG. 3 is a flowchart 200 of a method of scanning according to an embodiment of the present invention and FIG. 4 is a top plan view of a platen of a scanner to illustrate a scanning operation according to an embodiment of the present invention. An object 302 to be scanned, such as a document, a photograph, a negative, a transparency, or another item, is placed on platen 300 of the scanner. As set forth in detail below, the initial and final scan operations of the present invention involve only a single cycle or a single roundtrip of the carriage. During the initial scan operation the carriage moves from home position 304 towards end position 306 performing an initial scan of object 302 at a predetermined low resolution. During the final scan operation the carriage moves from end position 306 back to its original home position 304 performing the final scan operation. As discussed in detail below, if the user sets one or more parameters prior to initiation of the final scan operation, then the final scan operation is performed based at least in part on parameters set by the user. Otherwise, the final scan operation is preferably performed based at least in part on default values for the parameters.

As illustrated in the flowchart of FIG. 3, in step 202 an initial scan is started. During the initial scan the carriage moves from home position 304 towards end position 306 performing an initial scan of object 302 at a predetermined low resolution. For example, the resolution for the initial scan may be set at 75 dpi.

Home position 304 may be at a first end of platen 300 and end position 306 may be at an opposite end of platen 300. However, the invention is not so limited and in alternative embodiments the home and end positions may be selected to be anywhere along the length of platen 300. During the initial scan, the scanned portion of the object is substantially simultaneously displayed on a display associated with the computer system with which the scanner is coupled (step 203).

While the initial scan is being performed the user may select different parameters to be used in performing the final scan. The different parameters may be selected, for example, by using a graphical user interface of a software associated with the scanner. One or more of the following parameters may be selected by the user, for example scan area, resolution, exposure time, type of scan and the like.

In step 204, a determination is made as to whether the user has selected and set the value of any parameters during the initial scan. If the user has set one or more parameters, then in step 206 a final scan is performed based at least in part on the selected parameters. Thus, if the user has selected a particular resolution at which the user would like to scan the object, then in step 206, the object is scanned at the selected resolution. It may be noted that the final scan is performed by moving the carriage from end position 306 towards home position 304. The final scan is complete when the carriage reaches home position 304.

If the user has not selected and set one or more parameters to be used for the final scan, then in step 208, the final scan is performed based at least in part on default values for the various parameters. The default parameters are preferably set prior to initiation of the initial scan, for example when the scanner is coupled to the computer system. Preferably, the default parameters are set so as to provide the best image of an object. However, if desired, the default parameters may be set so that the final scan is performed in a predetermined time. In such a case, the default parameters to be used for the final scan may be set to a different value, for example, the resolution may be set to 300 dpi, thereby completing the final scan faster than it would be completed at 600 dpi.

During the final scan the carriage moves from end position 306 towards home position 304 performing the final scan based on the default parameters. The final scan is complete when the carriage reaches home position 304. In step 210 a final image file is obtained.

Assuming that the movement of the carriage from home position 304 to end position 306 to perform the initial scan takes Xᵢ units of time and the movement of the carriage from end position 306 to home position 304 to perform the final scan takes X_{f} units of time, the scanning operation of the preferred embodiment of the present invention takes (Xᵢ+X_{f}) units of time to complete a scan. Thus, by completing the scanning process in one cycle, the time for scanning may be reduced by (2*Xᵣ) units of time when compared to the prior art scanning operation as discussed above.

It may be seen from the foregoing that in an embodiment of the present invention, the complete scanning operation takes only one cycle. During the first part of the cycle an initial scan is performed from home position 304 to end position 306. During the second part of the cycle a final scan is performed from end position 306 to home position 304.

An advantage of the preferred embodiment of the present invention is that a final scanned image may be obtained faster than in prior art systems.

What is claimed is:

1. A method for scanning an object by an image scanner, comprising:
performing an initial scan of the object by displacing a carriage carrying a light source and at least one photosensitive device from a home position to an end position; and
performing a final scan by then displacing the carriage from the end position to the home position.

2. The method of claim 1, further comprising displaying, during the initial scan, at least a portion of an image of the object on a display associated with the image scanner.

3. The method of claim 1, wherein the final scan is performed based at least in part on at least one parameter set by a user prior to initiation of the final scan.

4. The method of claim 3, wherein said at least one parameter is selected from the group consisting of a scan area, a scanning resolution, a scan color type, and an exposure time.

5. The method of claim 1, wherein the final scan is performed based at least in part on at least one default parameter.

6. The method of claim 1, wherein the initial scan is performed at a low resolution to provide an initial image and the final scan is performed at a high resolution to provide a final scanned image.

7. An image scanner, comprising:
a platen;
a carriage disposed below the platen and having a displacement axis substantially parallel to the platen;
a light source and at least one photosensitive device disposed on the carriage; and
the carriage having a displacement from a home position to an end position along the displacement axis in an initial scan operation to provide an initial image of an object on the platen and a subsequent displacement from the end position to the home position in a final scan operation to provide a final scanned image of the object, wherein the carriage does not return to the home position between the initial scan operation and the final scan operation.

8. The image scanner of claim 7, wherein the initial scan operation is performed at a low resolution.

9. The image scanner of claim 7, wherein the final scan operation is performed at a high resolution.

10. The image scanner of claim 7, wherein the final scan operation is performed based at least in part on at least one parameter set by a user after initiation of the initial scan operation.

11. The image scanner of claim 7, wherein the final scan operation is performed based at least in part on at least one default parameter.

12. An image capture system, comprising:
a platen;
a carriage disposed below the platen and having a displacement axis substantially parallel to the platen;
a light source and at least one photosensitive device disposed on the carriage; and
the carriage having a displacement along the displacement axis from a home position to an end position in a first scan operation and a subsequent displacement from the end position to the home position in a second scan operation, wherein the carriage does not return to the home position between the first scan operation and the second scan operation.

13. The image capture system of claim 12, wherein the first scan operation provides an initial scanned image of an object on the platen and the second scan operation provides a final scanned image of the object.

14. The image capture system of claim 13, wherein during the first scan operation at least a portion of the initial scanned image is displayed on a display associated with the image capture system.

15. The image capture system of claim 12, wherein the first scan operation is performed at a low resolution.

16. The image capture system of claim 12, wherein the first scan operation and the second scan operation are performed at the same resolution.
